(19) United States
(12) Patent Application Publication
(10) Pub. No.: US 2012/0296526 A1
(43) Pub. Date: Nov. 22, 2012

(54) CONTROL UNIT FOR SETTING A DEVICE FOR THE ADAPTIVE REDUCTION OF CRASH ENERGY FOR A VEHICLE, DEVICE FOR THE ADAPTIVE REDUCTION OF CRASH ENERGY FOR A VEHICLE AND METHOD FOR SETTING A DEVICE FOR THE ADAPTIVE REDUCTION OF CRASH ENERGY FOR A VEHICLE

(76) Inventors: Heiko Freienstein, Weil Der Stadt (DE); Markus Koenning, Stuttgart (DE)

(21) Appl. No.: 13/510,752

(22) PCT Filed: Nov. 22, 2010
(86) PCT No.: PCT/EP2010/067913

§ 371 Date: Aug. 3, 2012

(30) Foreign Application Priority Data
Nov. 23, 2009 (DE) 102009046984.2

(51) Int. Cl. B60R 21/0134

(52) U.S. Cl. 701/45

(57) ABSTRACT

A control unit for setting a device for the adaptive reduction of crash energy for a vehicle includes a first interface which provides a first signal characterizing an imminent or a beginning crash process, a computing element which, as a function of the first signal, generates a first control signal for setting the deformation behavior of at least one deformation element of the device for the adaptive reduction in the crash energy, and a second interface which provides a second signal characterizing at least one passenger parameter that changes as a function of the crash process. The computing element generates at least one second control signal as a function of the second signal for setting the deformation behavior during the crash process.

### BACKGROUND OF THE INVENTION

1. Field of the Invention

The present invention relates to a control unit for setting a device for the adaptive reduction of crash energy for a vehicle and a device for the adaptive reduction of crash energy for a vehicle and a method for setting a device for the adaptive reduction of crash energy for a vehicle.

2. Description of Related Art

It is known from Wittemann W (2005), Adaptive Frontal Structure Design to achieve Optimal Deceleration Pulses, 19th International Technical Conference an the Enhanced Safety of Vehicles, Washington D.C., USA, Paper No. 05-0243, that for crash compatibility it is necessary to provide a more rigid structure in the case of a severe accident opposing party and a more yielding structure in the case of a lighter accident opposing party. Friction is regarded as being the best energy absorption method. A regulation for the rigidity may be provided before and during the crash.

A crash box is known from European patent application document EP 1 792 786 A2, which has a housing-type deformation profile having a flange plate at the long channel bar end of the chassis frame, and is developed as a folded construction of sheet metal. The deformation profile is made up of two shell components, a flange plate section being attached to each shell component. The shell components are folded from initial mounting plates made of sheet metal, that are subsequently assembled and joined together using resistance welding points. This represents a usual crash box without any adaptation to a crash process. However, such an adaptation is known from published German patent application document DE 197 45 656 A1, for example. In that instance, a crash damper for a vehicle is proposed, a deformation being able to be controlled as a function of a precrash signal, that is, a signal of an all-around view sensor system such as on a radar sensor system or a crash signal. On a deformation element, it is proposed that sliders move perpendicular to the direction of force and thereby block the deformation elements, so that because of the force effect, these deformation elements reduce the crash energy by the plastic deformation based on the blocking. An adaptation to the crash process is possible because of a parallel arrangement or by an interconstruction of such deformation elements. As a further example, it is proposed to use a deformation element for the reduction of crash energy by tapering. In this instance, an element is fixed for tapering and an additional one is able to be released by a slider so as to reduce the tapering. The motion of the slider takes place in radial fashion, in this instance, i.e. perpendicular to the direction of force, and thus to the longitudinal axis of the deformation element, usually a cylinder having a specified wall thickness.

### BRIEF SUMMARY OF THE INVENTION

By contrast, the control unit for setting a device for the adaptive reduction of crash energy for a vehicle, and the device according to the present invention for the adaptive reduction of crash energy for a vehicle, and the method according to the present invention for setting a device for the adaptive reduction of crash energy for a vehicle have the advantage that a regulation takes place of the deformation behavior to at least one passenger parameter, which changes as a function of the crash process. With that, the biomechanical stress of the vehicle's passengers during a crash may be optimized. And with that, the consequences of the accident may then be reduced.

A control unit, in this instance, is an electrical unit which processes the signals provided and outputs control signals as a function thereof. Such a control unit may be enclosed by a housing or sheeting. The control unit has either its own sensors, such as for measuring the acceleration or the deceleration during a crash and/or or is connected to sensors situated outside the control unit which are situated at the front of the vehicle and/or at the side of the vehicle or in a sensor control unit.

The device has the mechanical parts provided for the reduction in the crash energy. As may be inferred from the dependent claims, it is possible that the device itself includes the control unit. However, the control unit may also, for instance, be a control unit for controlling personal protective means, that is, it controls air bags, seat belt tensioners, etc. Additional configurations of the control unit are also possible.

Adaptive reduction in the crash energy means that the energy, created by the impact, is adapted to the crash process, and in the present case is reduced by the deformation of parts that are provided. This reduced energy can no longer act upon the vehicle's passengers. Therefore, the adaptation takes place as a function of sensor signals measured during the crash process or before the crash process, such as signals from a precrash sensor system and/or a crash sensor system. The precrash sensor system may be radar, video, ultrasound or other technologies, while an impact sensor system is usually at least an acceleration sensor system, but may also be a structure-borne noise sensor system, a deformation sensor system and also an air pressure sensor system, for example, that is situated in the side parts of the vehicle.

The vehicle is usually a motor vehicle, for instance, a passenger car.

The interfaces, in the present case, are either hardware and/or software interfaces. The hardware interfaces may, for instance, be situated on user-specific integrated circuits and/or an integration may take place via software interfaces, in a microcontroller, for example.

The first signal is defined as characterizing an imminent or beginning crash. It follows from this that the first signal has either data from so-called precrash sensor systems, such as an all-around view sensor systems, such as video, radar, lidar, ultrasound, etc., or during a beginning crash, from a crash sensor system such as an acceleration sensor system of a structure-borne noise sensor system or an air pressure sensor system, etc. The first signal may represent the raw data coming from the sensor system, may represent preprocessed data or already a triggering decision, a triggering time, a crash severity or similar results of an algorithm which, for instance, is processing a sensor signal for generating the first signal.

The concept of “crash process” denotes the crash from its beginning to the end. The beginning may be characterized, for example, by the exceeding of a noise threshold by the acceleration signal at 3 to 6 g (=gravitational acceleration), or by an estimate from a radar signal, in order to determine the point in time of impact or by a reverse calculation of the point in time of impact from the curve of the acceleration signal or another impact signal.

By calculating element one may understand a processor, an integrated circuit, a discrete circuit or even a software module, that will execute the calculating operations required according to the teaching of the claims. Preferably one may understand this to be a microcontroller. This computing element evaluates the first signal, for instance, a precrash sensor signal, and as a function of this, it generates a first control signal for setting the deformation behavior of at least one deformation element of the device for the adaptive reduction of the crash energy.

The precrash sensor signal should be constituted in such a way that, after suitable evaluation, it supplies data on the impending crash. These data may include speeds, angles of approach, the degree of vehicle overlapping, the point of impact of the vehicles and the mass or rigidity of the vehicles participating in the accident. From these data, an estimated crash scenario is ascertained.

Accordingly, the control signal tells how the crash scenario is looking. For this purpose, the device usually has an evaluation which is able to interpret this control signal. After that, the setting of the deformation behavior takes place, for instance, or in particular, the rigidity. The deformation behavior is adapted before or during the impact on the crash scenario, by setting the deformation element. This deformation element deforms plastically, so that by this plastic deformation the reduction of the crash energy comes about. The more rigid the deformation element, the more is the amount by which the crash energy can be reduced.

According to the present invention, the second signal is defined with the aim of characterizing at least one passenger parameter that changes as a function of the crash process. This passenger parameter may be, for instance, the forward displacement, the speed, the acceleration of the passengers. This may be estimated from the estimated or measured acceleration signal itself, for example. At this point, a suitable passenger model in simplified form may be stored, which reaches a value of the forward displacement of the passengers as a function of the measured vehicle deceleration, for instance, by a polynomial function. It is also possible, however, to detect this by using a passenger sensor system. The passenger sensor system can perform its measurement via a camera or using a force-measuring bolt in the seating, via a seat mat, ultrasound, radar or other known methods from the related art. Parameters which do not change as a function of the crash process are not pertinent to this, such as, for example, the weight of the vehicle passengers. The second control signal is generated as a function of this second signal. This takes place during the crash process, in order to change the crash behavior during the crash process, which brings about the abovementioned advantage. The second control signal is developed similarly to the first control signal.

The at least one deformation element is a structure of metal, for instance, or plastic, material composits or other materials which are tapered in order to reduce crash energy by this plastic deformation. But a deformation element that is pressed together and thereby is plastically deformed is also suitable in the case at hand.

It is of advantage that the computing element determines a passenger forward displacement with the aid of the second signal, and from this determines a restraint action of at least one personal protective means, the second control signal stating a reduction in rigidity with respect to the deformation behavior. In this instance, the passenger forward displacement is the path that the passenger covers as a result of the crash process, from his initial position at the beginning of the crash process. Thus, the restraint action is the force that an air bag or seat belt tensioner exerts on the passenger to restrain him. The present invention recognized that when the vehicle passenger feels the restraint action, he is being protected by this restraint action. Even at the beginning of the crash process, if the vehicle passenger moves freely towards the steering wheel, in the case of the driver, a high rigidity may be specified by the device according to the present invention, since no biomechanical effects on the vehicle passenger are to be expected. However, if a biomechanical effect is to be expected, such as during an impact of the vehicle passenger on the air bag, in this phase, in which the impact is to be expected, the rigidity is reduced, so as, in that way, to reduce the biomechanical effects on the vehicle passenger. Besides the air bags, seat belt tensioners, crash-active head rests, etc. should be regarded as such personal protective means.

It is furthermore advantageous that the at least one second control signal influences the deformation behavior with respect to the rigidity, in such a way that a path of the passenger, as a result of the crash, from its position at the beginning of the crash process to the beginning of the restraint effect is maximally utilized by at least one personal protective means, in order to reduce stress on the passenger. This describes once more functionally that during the so-called free flight of the passengers, a great reduction in the crash energy is able to take place, and also during the dipping of the vehicle passenger into the air bag, but not during the impact on the air bag. The maximum utilization originates with the fact that during the path the vehicle passenger covers from his initial position until his impinging on his airbag is used for reducing the crash energy.

It is further advantageous that the computing element determines a crash severity with the aid of the second signal, and with the aid of the crash severity it generates the at least one second control signal. The speed at which the vehicle passenger covers the distance from his initial position to the unfolded air bag, is a measure for the crash severity. For this, a Taylor Series may be developed as a function of the acceleration signal or a signal derived from it. By crash severity, a measure is understood to mean how great are the results for the vehicle passenger.

It is of advantage that the control unit is installed in the device. That being the case, a self-sufficient device may be installed, particularly if it is also equipped with the appropriate sensor system. Alternatively, it is possible for the device also to have an interface to which the control unit or other control units may additionally be connected.

As was indicated above, the device advantageously has a first deformation element which becomes tapered so as to deform plastically, and thereby to reduce the crash energy, an actuating system being also provided for setting this tapering as a function of the first and/or the second control signal. This actuating system may, for instance, function inductively, using motors or other methods, which are in a position to hold the so-called die plates which are used for the tapering, so that these die plates are not pressed away to the side by the deformation element.

The device advantageously has still a second deformation element which is compressed as a result of the deformation, support elements being provided which the second deformation element releases for deformation as a result of the first and/or the second control signal. A combination of the first and the second deformation element in the same device is of particular advantage, in this context, since thereby certain force levels may be determined in a different manner.

### BRIEF DESCRIPTION OF THE DRAWINGS

FIG. 1 shows a block diagram of the device according to the present invention having the control unit according to the present invention.

FIG. 2 shows a block diagram of the control unit of the present invention.

FIG. 3 shows a sequence of force levels for adapting to the respective crash process.

FIG. 4 shows the individual phases a vehicle passenger experiences during a crash process.

FIG. 5 shows a force/time diagram.

FIG. 6 shows a flowchart.

FIG. 7 shows a cutout of a device for reducing crash energy.

### DETAILED DESCRIPTION OF THE INVENTION

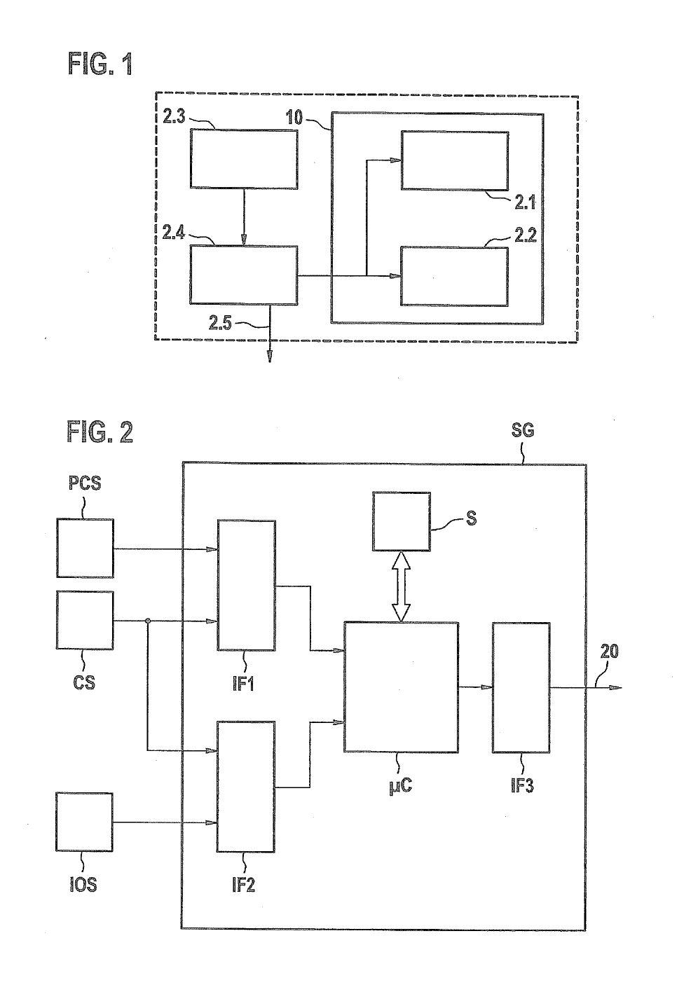

FIG. 1 shows device 10 of control unit 2.4, as well as a sensor system 2.3, according to the present invention.

Sensor system 2.3, which supplies the first and the second signal, these two also being able to be identical, and differing only in their time curve, i.e. the first signal takes place earlier than the second signal, may be a crash sensor system, an acceleration sensor system, a precrash sensor system, such as a radar sensor system, etc., and/or even a sensor system for recording the at least one passenger parameter, such as a video sensor system. Control unit 2.4 processes the first and the second signal in the manner according to the present invention, in order to generate the first and the second control signal. The first control signal goes to unit 2.1, in this instance, which leads to a setting of the deformation behavior. In this context, for example, an appropriate tapering of the deformation element can be set. The second control signal goes to device 2.2, for setting the deformation during the crash process. This may then take place via a second deformation element, so that different deformation characteristics are able to be set. The second control signal is also able to influence the degree of tapering, for example, in that a tapering stage is taken back and instead, the deformation is influenced by mechanism 2.2, by now deforming a deformation element that is pressed together or compressed. Via line 2.5, a data traffic is carried out by control unit 2.4 with other control units, in order to supply to these control units the sensor data and the corresponding evaluations.

In a block diagram, FIG. 2 shows the control unit SG having connected components. Via a first interface IF1, which may be developed along hardware and/or software lines, a crash sensor system CS and a precrash sensor system PCS are connected. The signals from these sensors are passed on to a microcontroller μC as the computing element. With the aid of these signals, which form the first signal, microcontroller μC determines the first control signal aided by a memory S, which, however, may also be situated on chip on microcontroller μC. As a function of this evaluation, the first control signal is output via interface IF3, via line 20. However, control unit SG has an additional interface IF2, to which crash sensor system CS and a passenger sensor system IOS are connected. The connection of crash sensor system CS is optional and not obligatory. Also, interface IF2 is connected to the microcontroller for the transmission of data from the sensors, and the microcontroller determines, again with the aid of memory S, the second control signal, which is passed on via interface IF3 and line 20 to the device according to the present invention.

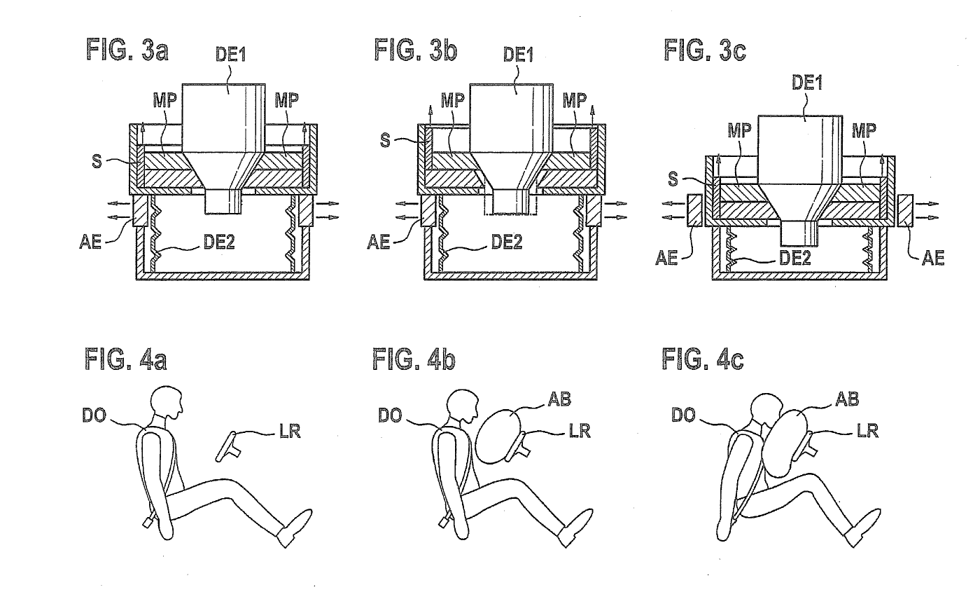

FIG. 3, in images a, b and c, shows how the deformation behavior is set during the crash process. At the beginning of the crash process in FIG. 3a, deformation element DE is driven through die plates MP, and thus experiences tapering and with that, a plastic deformation which leads to the reduction in crash energy. Die plates MP are held by sliders S, and thus they are not pushed away by deformation element DE. There is still another deformation structure present, namely having support elements AE as well as a second deformation element DE2, which already has a structure which makes possible the compression of this second deformation element DE2 in a simple manner. All the components at hand are executed to be rotationally symmetrical. That being the case, deformation element DE2, too, is a tube. Support elements AE conduct away the energy which is passed on via the structure having the tapering. In FIG. 3b, the tapering is moved back by moving sliders S upwards, so that the lower die plate MP is moved to the side and thus no longer leads to the tapering. This means a little less in reduced crash energy. In FIG. 3c, however, support elements AE have been moved farther outwards, and die plates MP are held again by sliders S, so that both a maximum tapering and, because of the compression of deformation element DE2, also a maximum possible reduction in plastic energy takes place because of the device according to the present invention. This may happen particularly when the vehicle passenger has dipped into the air bag.

FIG. 4, in Figures a to c, shows the various phases for vehicle passenger DO, with respect to steering wheel LR and air bag AB. In FIG. 4a there is no, or only very little linking of the passenger to the vehicle. The passenger is not connected to the means of restraint because of the slack in the seat belt and because there is no contact with the air bag. A short high acceleration peak does not lead to any negative biomechanical stress. The high deceleration already takes some energy out of the crash and supplies signals for the triggering of the personal protective means. FIG. 4b is the middle crash phase, while FIG. 4a describes the early crash phase. In the middle crash phase, the means of restraint, such as the air bag, unfold their effectiveness. The vehicle passenger builds up speed relative to the vehicle. The stress on the passenger is able to be reduced by a lesser speed relative to the air bag when impinging upon the air bag. That is why a lesser deceleration compared to the earlier phase is of advantage. In the final crash phase according to FIG. 4c, both the air bag and the seat belt connect the passenger to the vehicle and operate optimally, for instance, using force limitation. The energy may be taken out of the system by high deceleration. The passenger is connected optimally to the so-called vehicle ride down, by the well set means of restraint. The vehicle ride down is the deceleration of the vehicle. The passenger is connected to the deceleration of the vehicle, so that his speed relative to the vehicle structure (for example, the steering wheel or the instrument console) is reduced over the entire internal space that is available.

At this point, a high level of deceleration is required. Systems of restraint are set in a force-limiting manner in such a way that deceleration peaks and a comparatively high deceleration level leads to an optimal biomechanical stress.

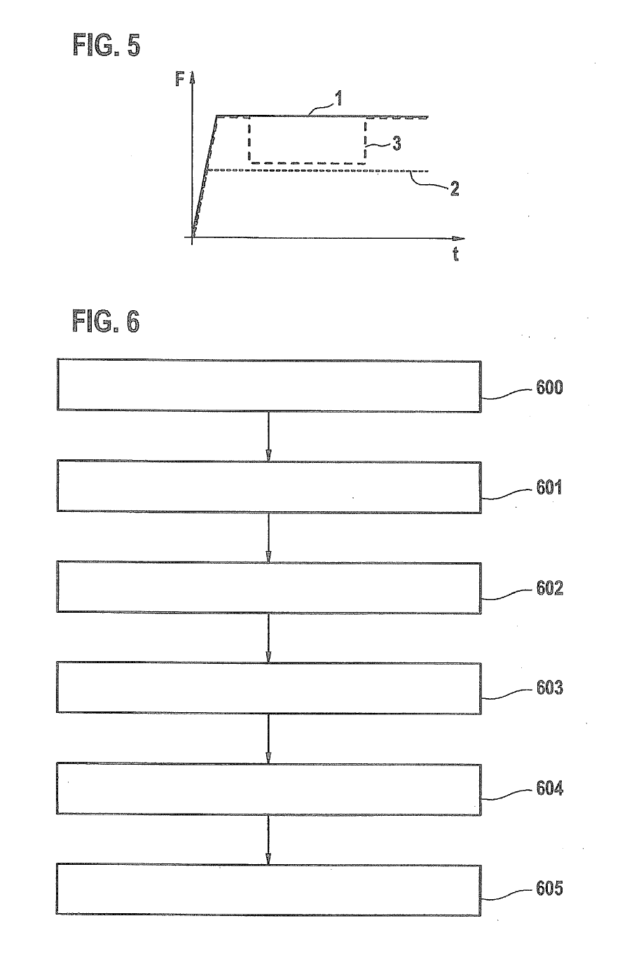

FIG. 5 shows a force/time diagram, The force is designated in this context by F as the ordinate and the time by t on the abscissa. The force shown is the force level of the vehicle's front end, which also controls the passenger motion. By curves 1, 2 and 3, FIG. 5 shows the cases shown in FIGS. 3a, b and c. Case a corresponds to case 1, FIG. 3b corresponds to case 2 and FIG. 3c corresponds to curve 3. On curve 3, the force level drops off, in order to reduce the speed absorption of the passenger relative to the vehicle structure. This is made possible by the additional deformation structure DE2. After the contact with the means of restraint, increase in the force again takes place.

FIG. 6 shows a flow chart of the present invention. In this instance, in step 600 a first signal is provided, which characterizes an imminent or beginning crash process. As a function of the first signal, in step 601, a first control signal for setting a deformation behavior of at least one deformation element of the device, for the adaptive reduction in the crash energy, is then generated in step 602.

In step 603, the second signal is then provided, which characterizes at least one passenger parameter that changes as a function of the crash process. In succeeding step 604, a second control signal is generated as a function of the second signal for setting the deformation behavior during the crash process in step 605.

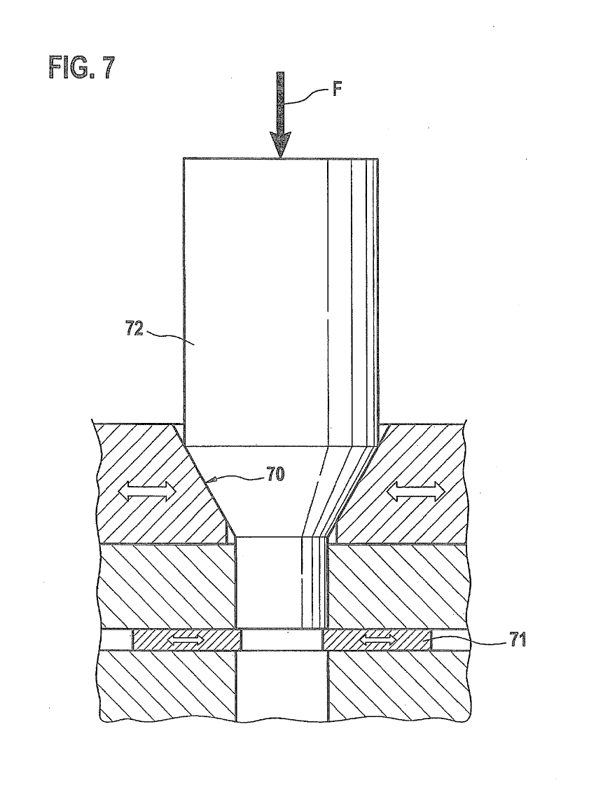

FIG. 7 shows a cutout of a device for the reduction in the crash energy: Deformation element 72 is pressed through an absorber 70 by crash energy F. Slider 71 is a preset breaking point. If it is activated, a high initial level is generated. Then slider 71 breaks, deliberately under the enduring load. Tapering absorber 70 becomes effective. The force level drops off. When absorber 70 is used up, other structures in the front end deform, and the level rises again. In this implementation, no switching has to be performed during the crash. The breaking of slider 71 is the switch.

1-10. (canceled)

11. A control unit for controlling a device for an adaptive reduction in crash energy for a vehicle, comprising:
a first interface which provides a first signal characterizing an imminent crash process for the vehicle;
a second interface which provides a second signal characterizing at least one passenger parameter which changes as a function of the crash process; and
a computing element which generates: (i) a first control signal as a function of the first signal, wherein the first control signal sets a deformation behavior of at least one deformation element of the device for the adaptive reduction in crash energy; and (ii) at least one second control signal as a function of the second signal for controlling the deformation behavior during the crash process.

12. The control unit as recited in claim 11, wherein:
the computing element determines a passenger forward displacement with the aid of the second signal;
the computing element determines, based on the passenger forward displacement, a beginning of a passenger restraint action of at least one passenger protection device; and
the at least one second control signal indicates a reduction in a rigidity with respect to the deformation behavior.

13. The control unit as recited in claim 12, wherein the at least one second control signal influences the rigidity with respect to the deformation behavior in such a way that a path of a vehicle passenger, as a result of the crash, from a beginning position of the passenger at the beginning of the crash process to the beginning of the passenger restraint action by the at least one passenger protective device, is maximally utilized in order to reduce stress on the vehicle passenger.

14. The control unit as recited in claim 12, wherein the computing element determines a crash severity with the aid of the second signal, and the computing element generates the at least one second control signal with the aid of the determined crash severity.

15. A device for the adaptive reduction of crash energy for a vehicle in a crash process, comprising:
at least one deformation element having deformation behavior which is set as a function of a first control signal for an adaptive reduction of the crash energy;
wherein the deformation behavior of the at least one deformation element is controlled during the crash process as a function of at least one second control signal generated as a function of at least one passenger parameter which changes as a function of the crash process.

16. The device as recited in claim 15, further comprising:
a control unit including:
a first interface which provides a first signal characterizing an imminent crash process for the vehicle;
a second interface which provides a second signal characterizing at least one passenger parameter which changes as a function of the crash process; and
a computing element which generates: (i) the first control signal as a function of the first signal; and (ii) the at least one second control signal as a function of the second signal.

17. The device as recited in claim 15, further comprising:
a first interface which provides a first signal characterizing an imminent crash process for the vehicle; and
a second interface which provides a second signal characterizing at least one passenger parameter which changes as a function of the crash process;
wherein the first control signal is generated as a function of the first signal, and the at least one second control signal is generated as a function of the second signal.

18. The device as recited in claim 15, wherein the at least one deformation element includes a first deformation element which is tapered for the reduction of the crash energy, and wherein an actuator system is provided for setting the tapering of the first deformation element as a function of at least one of the first and second control signals.

19. The device as recited in claim 18, wherein the at least one deformation element further includes a second deformation element which is situated in such a way that the second deformation element is compressed as a result of the deformation, and wherein at least one support element is provided for releasing the second deformation element for the deformation as a function of at least one of the first and second control signals.

20. A method for controlling a device for adaptive reduction of crash energy for a vehicle, comprising:
generating a first signal characterizing an imminent crash process for the vehicle;
generating a second signal characterizing at least one passenger parameter which changes as a function of the crash process;
generating, as a function of the first signal, a first control signal for setting a deformation behavior of at least one deformation element of the device for the adaptive reduction in the crash energy; and
generating, as a function of the second signal, at least one second control signal for controlling the deformation behavior during the crash process.
